(19) United States
(12) Patent Application Publication
(10) Pub. No.: US 2025/0353767 A1
(43) Pub. Date: Nov. 20, 2025

(54) FLUORESCENT ENGINEERED SILICON QUANTUM DOTS (SiQDs) AS AN EFFICIENT SCALE INHIBITOR

(71) Applicant: University of North Dakota, Grand Forks, ND (US)

(72) Inventors: Ali Alshami, Grand Forks, ND (US); Nadhem Ismail, Grand Forks, ND (US); Di Sun, Grand Forks, ND (US); Julia Xiaojun Zhao, Grand Forks, ND (US)

(21) Appl. No.: 19/210,541

(22) Filed: May 16, 2025

Related U.S. Application Data
(60) Provisional application No. 63/649,205, filed on May 17, 2024.

(51) Int. Cl. C02F 5/10

(52) U.S. Cl. CPC C02F 5/105; C02F 2209/00; C02F 2305/08

(57) ABSTRACT

A nanophotonic scale inhibitor includes a silicon quantum dot core having a functionalized surface including a plurality of carboxyl groups, sulfonate groups, or phosphonate groups. A method for synthesizing a nanophotonic scale inhibitor material includes preparing silicon quantum dots for surface functionalization and functionalizing surfaces of the silicon quantum dots with one of a carboxyl group, sulfonate group, and phosphonate group. A method of inhibiting and monitoring scale formation in water systems includes providing the nanophotonic scale inhibitor to the water in the water system and visualizing scale formation by detecting fluorescence of the nanotphotonic scale inhibitor.

### CROSS-REFERENCE TO RELATED APPLICATION(S)

This application claims the benefit of U.S. Provisional Application No. 63/649,205 filed May 17, 2024, for “FLUORESCENT ENGINEERED SILICON QUANTUM DOTS (SiQDs) AS AN EFFICIENT SCALE INHIBITOR” by A. Alshami, N. Ismail, D. Sun, and J. X. Zhao.

### STATEMENT OF GOVERNMENT INTEREST

This invention was made with government support under a contract awarded by the North Dakota Industrial Commission. The government has certain rights in the invention.

### FIELD OF INVENTION

The present disclosure relates generally to antiscaling compositions and methods of inhibiting scale formation. In another aspect, this disclosure relates to fluorescent scale inhibitors and monitoring and control of water systems. In a further aspect, the disclosure relates to the use of scale inhibitors containing fluorescent moieties therein in industrial water systems.

### BACKGROUND

Current water treatment additives used to mitigate unfavorable waterborne species, such as scaling ions, pose threats to the environment and necessitate the development of green alternatives. The post-process disposal of petroleum-derived water treatment chemicals is a significant issue in water-based industries. The accumulation of toxic and non-degradable materials, along with the anthropogenic side effects of phosphorus-containing agents, affect the aquatic and terrestrial ecosystems.

The formation of sparingly soluble salts, known as scaling, is a persistent problem in blue economy sectors. Applying optimum amounts of scale inhibitors can effectively prevent scale formation. Chemical reagents bearing negatively charged nitrogen, phosphorus, and sulfur-enriched functional groups have been the focus of scale inhibitor studies due to their high metal cations affinity and the ability to interfere in the early crystallization stages, thereby hindering scale formation. The associated environmental and anthropogenic side effects of these inhibitors make them less desirable despite their threshold inhibition performance, which has motivated water-based industries to adopt green technologies, including carboxylated molecules, leading to a surge in efforts dedicated to chemically amending and designing functional molecules and nanoparticles, which allows them to perform similarly to their phosphonated counterparts while preventing adverse environmental side effects.

Water treatment technologies have focused on developing phosphorous-free antiscalants. Various carboxylated molecules and macromolecules, such as carboxylated quantum dots, poly (acrylic acid), poly (maleic acid), poly (epoxy-succinic) acid, and their derivatives, have become a subject of intense discussion, both in theory and application. While multiple initiatives have focused on developing environmentally friendly antiscalants, most of the developed green antiscalants have low scaling ion tolerance and unknown underlying scale inhibition mechanisms. Antiscalants with fluorescent properties have the potential to provide insights into scale inhibition mechanisms. Antiscalants tagged with inert fluorescent fragments have been developed to facilitate monitoring in water treatment systems. Tagging antiscalants, however, can increase formulation costs and can negatively affect the efficacy of the antiscalant. Quantum dots (QDs) have attracted attention due to their unique structural and photonic properties.

Challenges associated with green antiscalants, such as relatively low antiscaling efficiency, low calcium tolerance, high synthesis cost, and unknown underlying antiscaling mechanisms, have prevented industries from implementing green technologies despite their ability to potentially decrease carbon footprints. There is a need to develop tailor-made and cost-effective antiscalants that inhibit scale formation mechanisms while maintaining high efficiency and calcium tolerance.

### SUMMARY

A nanophotonic scale inhibitor includes a silicon quantum dot core having a functionalized surface including a plurality of carboxyl groups, sulfonate groups, or phosphonate groups. A method for synthesizing a nanophotonic scale inhibitor material includes preparing silicon quantum dots for surface functionalization and functionalizing surfaces of the silicon quantum dots with one of a carboxyl group, sulfonate group, and phosphonate group. A method of inhibiting and monitoring scale formation in water systems includes providing the nanophotonic scale inhibitor to the water in the water system and visualizing scale formation by detecting fluorescence of the nanotphotonic scale inhibitor.

The present summary is provided only by way of example, and not limitation. Other aspects of the present disclosure will be appreciated in view of the entirety of the present disclosure, including the entire text, claims and accompanying figures.

### BRIEF DESCRIPTION OF THE DRAWINGS

FIG. 1 is a flowchart of a method for synthesizing surface functionalized silicon quantum dots (SiQDs).

FIG. 2 is a flowchart of a method for inhibiting and monitoring scale formation a water system with the nanophotonic scale inhibitor formed by the method of FIG. 1.

FIG. 3 is a schematic diagram illustrating CSiQDs functionalization.

FIGS. 4A-4C are graphs illustrating calcium sulfate scale inhibition efficiencies at 70° C. for different inhibitor dosages.

FIGS. 5A and 5B illustrate the effect of temperature and pH on gypsum scale inhibition performance.

FIG. 6 is a illustrates heterotrophic plate counts (HPC) of feed water samples treated with commercial antiscalants and different concentrations of CSiQDs.

While the above-identified figures set forth embodiments of the present invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps and/or components not specifically shown in the drawings.

### DETAILED DESCRIPTION

The present disclosure is directed towards scale inhibiting compositions and methods for inhibiting scale formation. In particular, the present disclosure relates to the synthesis and testing of surface engineered fluorescent silicon quantum dots as an efficient scale inhibitor in water-based industries. The core fluorescent silicon quantum dots (SiQDs) can be synthesized in a streamlined one step method, then surface engineered by the introduction of functional moieties (i.e., carboxyl, sulfonate, and green phosophonate). The final engineered product has been applied, for the first time, in ppm levels to retard and suppress sulfate and carbonate scales that form in industrial water systems (i.e. oilfield and reverse osmosis facilities, boilers, heat exchangers, evaporation plants, etc.).

SiQDs are particularly attractive for water purification applications due to their excellent photonic properties, water solubility, low cost, and surface functionalization. The diversity of these properties is contingent upon SiQDs structure and composition, which is primarily determined by the synthesis method and the subsequent surface modification. The presence of hydrophilic functional groups, such as —NH₂ and—COOH, on the SiQDs surface promotes stability and water solubility. These functional groups are highly dense due to the high surface area (A) to volume (V) ratio promoting scaling ions chelation, and adsorption capacity on scale crystal growth active sites. As discussed by way of example herein, carboxyl SiQDs (CSiQDs), have been demonstrated to have excellent scale-inhibiting properties.

The present disclosure advances nano-photonic scale inhibitor material design through synthesis and testing novel fluorescent and highly functionalized SiQDs. The developed inhibitor's remarkable properties include better scale inhibitor concentration control in industrial applications, better elucidation of scale inhibition mechanisms through the scaling process, and the ability to use antiscalant visualizations on scale cores due to the fluorescence properties of the material. The ability to develop tailored formulations that target specific water compositions and different scale types is enabled by facile surface functionalization with diverse groups, such as carboxyl, sulfonate, and green phosphonates. As discussed further herein, high efficiency was attained by the developed formulation's high surface area to volume ratio.

Besides biocompatibility and environmental friendliness, the underlined features of the formulated scale inhibitor disclosed herein are the innate flouresence properties and the 100% inhibition efficiency with reduced antiscalant concentrations at different brine stresses and testing conditions. The inherent flouresence properties advance real-time monitoring capabilities without the need of bearing an inert fluorescent fragment. In addition, the inherent flourecene properties offer a unique opportunity for the development of the scale inhibition theory via the direct visualization of the scale inhibitor in various scale formation processes. The term “monitoring,” as used herein, refers to any type of tracing to determine the location or route of the formulation, and any type of concentration determination at any given site.

In one example, the surface of synthesized SiQDs was engineered by introducing carboxyl moieties. As discussed further herein, the functionalized or surface engineered carboxylated silicon quantum dots (CSiQDs) were characterized in terms of FTIR, XPS, HRTEM, DLS, zeta-potential, and fluorescence properties. The characterization results confirmed successful modification through the introduction of carboxyl groups while retaining excitation and emission properties. The engineered CSiQDs were evaluated by analyzing calcium sulfate (gypsum) scale at different brine stresses, temperature, and pH. The results revealed high efficiency of the CSiQDs, reaching 100% at a 20-ppm dosage in a brine containing 6,600 ppm of calcium and sulfate ions at 70° C. The gypsum scale inhibition mechanism was investigated using fluorescence images and morphology analysis by means of XRD and SEM in the presence and absence of CSiQDs. The CSiQDs inhibitor is believed to affect gypsum crystal nucleation and growth.

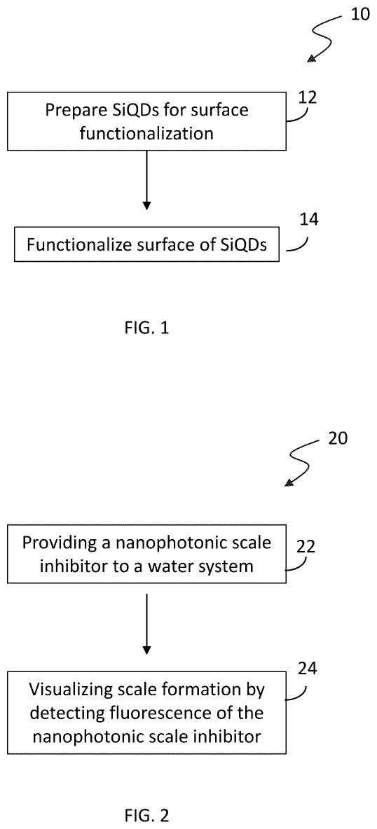

FIG. 1 is a flowchart of method 10 of synthesizing nanophotonic antiscalants (also referred to herein as “scale inhibitors”). In step 12, SiQDs are prepared for surface functionalization. SiQDs can be synthesized by methods known in the art, including, for example, synthesis from (3-Aminopropyl)triethoxysilane (APTES) in a modified hydrothermal method in the presence of D-glucose (reducing agent) or reduction of (3-Aminopropyl)triethoxysilane (APTES) with ascorbic acid. The resulting SiQDs have higly dense amino functional groups (NH₂) on their surface available for modification. The SiQDs can be dried before functionalization. Dried SiQDs can be dissolved in solvent with sonication to form a stable SiQD suspension (i.e., colloidal suspension). Any solvent capable of dissolving the SiQDs and functional group source reagent may be suitable. Ethyl acetate may be preferred due to its low toxicity and availability.

In step 14, surfaces of the SiQDs are functionalized with one of a carboxyl group, sulfonate group, and phosphonate group. Synthesizing well-dispersed nanoparticle-based scale inhibitors can be challenging due to difficulties related to having a stable colloidal dispersion in a salty brine solution. Difficulty in having a stable colloidal dispersion is associated with surface charge dependence of the nanoparticles on the brine salts concentration. The surface charge reaches zero at high scaling ions concentrations leading to lower salt tolerance and nanoparticle aggregation. The surface functionalized SiQDs suspension can be created through the highly dense functionalization of the SiQDs by introducing functional groups onto the silicon quantum dot surfaces utilizing the abundant amine groups originating from the APTES precursor used in the SiQDs synthesis.

Surface modification can be accomplished using different carboxyl source reagents. Carboxyl sources can include, for example, maleic anhydride (or similar cyclic anhydrides), acrylic acid, sodium chloroacetate, and combinations thereof, and bromoacetic acid. The detailed procedures of maleic anhydride and acrylic acid reactions are presented herein. In other examples, surface functionalization can be performed by introducing sulfonate or green phosphonate source reagents including, for example, sodium bisulfite or vinyl sulfonic sodium salt for sulfonate sources or phosphoric acid (coupled with an acid and formaldehyde system) for phosphonate sources. An excess amount of the functional group source reagent can be used in the functionalization process to ensure maximum functionalization.

Surface functionalization can be performed by introducing functional groups via direct covalent binding. For carboxylated SiQDs, the SiQD suspension can be mixed with the carboxyl group source, and the pH can be adjusted by addition of a suitable base (e.g., trimethylamine) to promote reaction. The adjusted pH can be within the range of 8-13. Preferably, the adjusted pH can be around 11, for example, between 11 and 11.5, however, lower pH values are suitable for promoting reaction. For phosphonated SiQDs, an acidic pH is required for reaction. Reaction can occur at relatively low temperature, for example, around 60° C. Higher temperatures can decrease reaction time but can increase volatilization of the solvent.

In step 16, unreacted products, including agglomerated SiQDs, can be filtered out and the resulting surface functionalized SiQDs can be dried. In one example, the surface functionalized SiQDs can range in size from 90 to 100 nm with the SiQD core of the surface functionalized SiQDs ranging in size from 3-10 nm. Functionalization of the SiQDs improves nanoparticle dispersion in water. The surface functionalized SiQDs appear monodispersed.

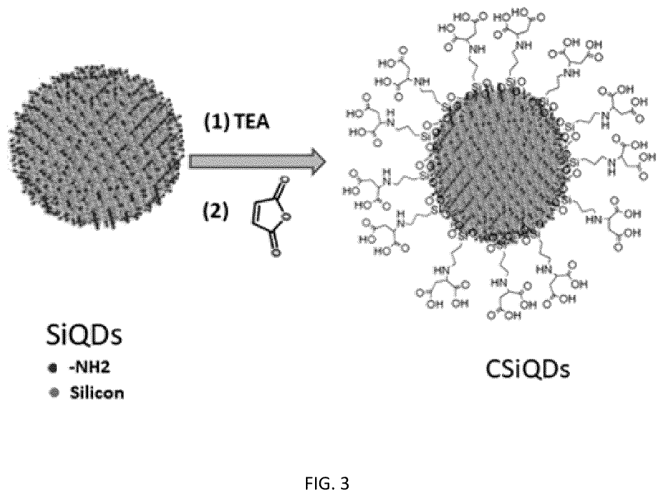

FIG. 2 is a flowchart of method 20 for inhibiting and monitoring scale formation a water system with the nanophotonic scale inhibitor formed by method 10 of FIG. 1. In step 22, the nanophotonic scale inhibitor is provided to the water system. In step 24, transport of the nanophotonic scale inhibitor and scale formation is monitored.

A concentration of the nanophotonic scale inhibitor can be selected based on a brine concentration of the water system and a desired scale inhibition efficiency. For example, the concentration of the scale inhibitor can be selected based on a calcium ion concentration, a sulfate ion concentration, and/or a bicarbonate ion concentration of the water system. To achieve a scale inhibition efficiency of approximately 80% or greater in most water systems the concentration of nanophotonic scale inhibitor can be within a range of 15 to 40 ppm, and typically within a range of 15 to 25 ppm (i.e., for water systems in which a calcium ion concentration is up to 3000 ppm and/or sulfate ion concentration is up to 7200 ppm, pH ranges from 5-7, and temperature is equal to or less than 70° C., which is significantly lower than prior art quantum dot antiscalants.

Monitoring of nanophotonic scale inhibitor transport and scale formation can be conducted by fluorescence-based monitoring methods known in the art including, for example, fluorescence spectroscopy and fluorometers. Fluorescence-based monitoring can be used to visualize the scale inhibitor on scale cores, RO membranes, and other engineering equipment surfaces.

### EXPERIMENTAL EXAMPLE

### Materials

Maleic anhydride and ethyl acetate (99% purity) were purchased from Fisher Scientific. Calcium chloride dihydride was supplied by Sigma-Aldrich (99% purity). Sodium sulfate was acquired from Across Organics (99% purity). All chemical reagents were of analytical grade and used as received without further purification. Other equipment used in the synthesis and testing include Thomas Scientific filter paper, a sonicator from Fisher Scientific, Pyrex volumetric flasks, 250 ml Fisher-brand glass jars, and an OAKLON pH meter.

### Synthesis and Funcionalization of CSiQDs

The SiQDs were synthesized from APTES in a modified hydrothermal method in the presence of D-glucose (reducing agent) as described in D. Sun et al., “Streamlined synthesis of potential dual-emissive fluorescent silicon quantum dots (SiQDs) for cell imaging,” RSC Adv., vol. 13, no. 38, pp. 26392-26405, September 2023, doi: 10.1039/D3RA03669C. Briefly, 0.450 g D-glucose as a reducing agent was dissolved in 8.0 mL nitrogen (N2)-saturated water and stirred for 10 min at room temperature. After the formation of a homogeneous reaction solution, 2.0 mL of APTES was injected into the nitrogen-saturated solution and stirred for 10 min. Then, the mixture was transferred into a Teflon-lined stainless steel autoclave oven and incubated at 200° C. for 8 hours. The sample was naturally cooled down to room temperature and ultra-filtered (filter aperture: 0.10 μm) resulting in a dark red solution after the heating step. To remove unreacted materials including APTES and D-glucose at the end of the preparation, the 1 kDa Molecular Weight Cut Off (MWCO) Spectra/Por® standard regenerated cellulose pre-treated dialysis membrane was used to dialyze the SiQDs for 24 hours against deionized (DI) water. The prepared solution was collected and stored at 4° C. prior to use and was stable for at least two months based on morphometrical and optical analyses.

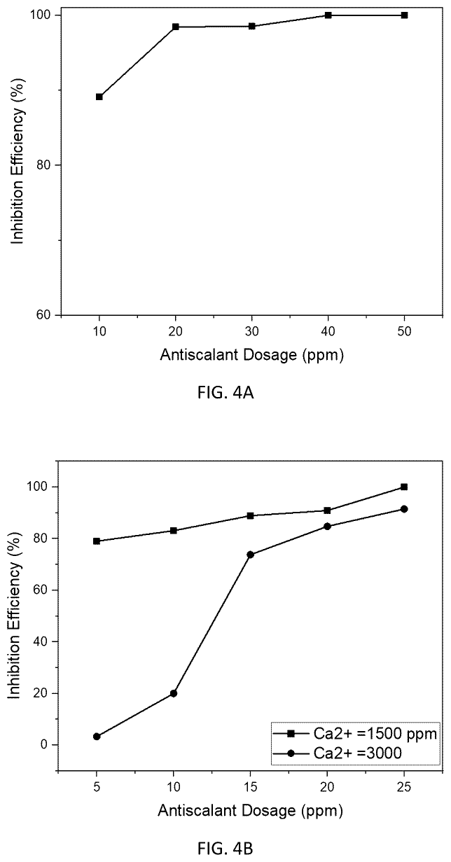

Following hydrothermal nucleation at 200° C., —NH₂ surface enriched SiQDs were further functionalized. Surface modification was accomplished using different carboxyl source reagents. The detailed procedures of maleic anhydride and acrylic acid reactions are presented herein. As illustrated schematically in FIG. 3, surface functionalization was performed by introducing carboxyl groups via direct covalent binding using the free carboxylate generated by opening the maleic anhydride cycle. In one example, functionalization involved dissolving 70 mg of dried SiQDs in 30 ml of ethyl acetate and then sonicating for 1 hour. 1 g of maleic anhydride was dissolved in 20 ml of ethyl acetate and placed in a round bottom reaction flask equipped with a condenser. The sonicated SiQDs solution was then added to the reaction flask, and the temperature was set at 60° C. while stirring at 350 rpm. The reaction's pH was adjusted to approximately 11 by adding 0.25 ml of trimethylamine. The crude yellow product was collected after 12 hours, filtered, and dried.

For acrylic acid reaction, 150 mg SiQDs was dissolved in 50 ml DI water and sonicated for 1 hr, then placed in a 3-neck round bottom flask equipped with a condenser. The reaction vessel was loaded with 0.2 g of acrylic acid dissolved in 10 ml DI water. The reaction pH was adjusted to approximately 11.5 by the addition of trimethylamine. The reaction mixture was stirred at 60° C. for 24 hours under nitrogen before collecting the product.

### Characterization

CSiQDs FTIR spectra was acquired using a Thermo Fisher Scientific Nicolet iS5 FT-IR spectrometer, while the photoluminescence (PL) spectra were obtained using a Shimadzu RF-6000 spectrophotometer. Dried CSiQDs product was dissolved in DI water prior to the PL analysis. An electron microscope (JEOL JEM 2100) was used to acquire the CSiQDs HRTEM images, which were acquired after dispersing a small amount of the sample in DI water for several minutes of bath sonication. 5 μL of the sonicated sample was then transferred to a 300 mesh FORMVAR-coated TEM grid and the liquid was wicked off, leaving sample material on the grid film. The CSiQDs were dispersed in DI water, then their size (nm distribution) and surface charge (zeta-potential) were obtained using a Malvern Nano-ZS Zetasizer. XPS analysis was performed on a Thermo Electron K-Alpha XPS instrument after the samples were mounted on double-sided carbon tape. Samples were pumped down to 1E-7 mTorr for 48 hours. A flood gun was switched on while performing the analysis to minimize surface charging. The survey scans were run at a pass energy=200 eV, number of scans=10, dwell time=10 ms, and energy step size=1 eV. The high-resolution scans were run for Si, P, C, N, and O with a pass energy=50 eV, number of scans=15, dwell time=50 ms, and energy step size=0.1 eV. X-ray diffraction (XRD) measurements were analyzed on a Rigaku Smart Lab diffractometer. Scale sample imaging, with and without CSiQDs scale inhibitor, was performed using an Olympus FV3000 laser scanning confocal microscope. Samples were put on the stage, one at a time, then the following imaging parameters were set: Magnification=63×/1.4 oil, 8 bits, zoom=1, and speed=600 Hz (862 ns/px).

Si—O—Si stretching appeared at 1007 cm⁻¹ in the FTIR spectra of the SiQDs. A characteristic peak at 3360 cm⁻¹ exhibited by the amino (NH₂) groups in the SiQDs in the amine region (3300-3500 cm⁻¹) corresponds to the vibration of the N—H bond in the —NH₂ groups. A peak at 2928 cm⁻¹ is associated with the stretching vibration of the methylene (—CH₂) in the alkane chain originating from the APTES precursor. New peaks appeared at 1703 cm⁻¹, 2873 cm⁻¹,3057 cm⁻¹, and 3530 cm⁻¹ upon functionalization. The peak at 1703 cm⁻¹ corresponds to the C—O stretching vibrations indicating the successful carboxyl functionalization. The peaks at 2873 and 3057 cm⁻¹ correspond to the C—H bond stretching vibrations of the aliphatic hydrocarbon chain formed after the opening of the cyclic anhydride during the functionalization. —OH stretching vibrations of the COOH groups appeared at 3530 cm⁻¹ in the FTIR spectra. All of these new peaks in the CSiQDs FTIR spectra confirm the SiQDs surface modification caused by introducing carboxyl groups. To support the FTIR spectra, HNMR of the modified silicon quantum dots was acquired.

CSiQDs fluorescence properties are important since they facilitate scale precipitation visualization, which helps with understanding the mechanisms of scale formation. The functionalized CSiQDs photoluminescence was confirmed using fluorophotometer analysis. The CSiQDs product appears brown in daylight and emits blue fluorescence with a wavelength of 460 nm when excited at 365 nm.

The size of SiQDs ranged from 3 to 10 nm with an average diameter of 4.8±0.5 nm. The dot sizes increased to a range of 90-100 nm upon functionalization, which was confirmed using DLS analysis. The bare SiQDs appear quasi-spherical and tend to agglomerate in their solid dry state due to surface tension; however, the functionalized CSiQDs appeared monodispersed, indicating that functionalization improved nanoparticle dispersion in water.

DLS measurements were collected to further confirm the CSiQDs size distribution and dispersion in DI water. The average size of the CSiQDs was approximately 95 nm, which reveals an increase from the size of the bare SiQDs due to functionalization. The charge of the carboxyl groups on the QDs surface was investigated using zeta-potential measurements, with an average value of −13.6 mV.

The surface composition of the SiQDs and CSiQDs was determined using XPS analysis. The XPS survey depicts four major peaks on both spectra. Major peaks at 98, 281, 398, and 528 eV correspond to Si2p, C1s, N1s, and O1s, respectively. Atomic percentages were calculated based on peak area, indicating an increase in oxygen and carbon atomic percentages resulting from the COO surface functionalization.

High-resolution XPS spectra was evaluated for Si2p, O1s, N1s, and C1s. A peak at 101.6 eV in the high-resolution Si2p XPS spectrum confirms the presence of silicon in the chemical environment Si—O, while the high-resolution O1s XPS spectrum confirms the presence of oxygen as O—Si at 532.29 eV. N1s high-resolution spectra reveal an N—H peak at 401.63 eV. The high-resolution C1s spectra reveal the existence of carbon in three chemical environments at binding energies of 284.48, 286.58, and 288.98 eV, corresponding to C—N, C—OH/C—O—C, and C═O, respectively. The XPS results confirm the diverse surface states of the functionalized quantum dots. The presence of the Si—O and C—O states further confirms carboxyl functionalization, in accordance with FTIR results.

### Anti-Scaling Tests

Anti-scaling or scale inhibition efficiency measurements were performed using a national standard (GB/T 16632-2008) at different temperatures, pH, and brine concentrations. The brine concentration variation experiments involved doubling cations concentration from C₁=1500 ppm Ca²⁺ to C₂=3000 ppm Ca²⁺, and the anions concentration was doubled from S₁=3600 ppm SO4²⁻ to S₂=7200 ppm SO4²⁻ CSiQDs efficiency was assessed at different brine stresses at dosages from 5-25 ppm.

Cationic and anionic brine solutions were prepared separately in 500 ml volumetric flasks, stirred for approximately 30 minutes at room temperature, and then filtered. 50 ml of each filtered sample was transferred into Pyrex glass jars. Seven solutions were used, including a bulk and a control sample for each anti-scalant concentration (5, 10, 15, 20 and 25 ppm). The cations and anions were then transferred and heated in an Isotemp pre-heated oven at the desired test temperature for at least 60 minutes before the tests began. The cations and anions were mixed, shaken, then returned to the oven as quickly as possible. Test solutions were kept at the desired temperature for approximately ten hours, then 10 ml from each test jar was filtered and diluted with 90 ml DI water. The samples were analyzed using ICP-OES for the remaining un-precipitated calcium ions. The same procedure was repeated at temperatures of 60, 70, and 80° C., and a pH of 4, 5, and 7. The inhibition efficiency was calculated by measuring the remaining calcium ions in solution after the testing period, according to the following equation:

$$Inhibition Efficiency ( IE \% ) = \frac{( {C}_{R} - {C}_{B} )}{( {C}_{C} - {C}_{B} )} \times 100$$

Where C_{R} is the remaining calcium ions in the filtrate after the test period, CB is the remaining calcium ion concentrations in the blank not treated with CSiQDs, and Cc is the control sample Ca²⁺ concentration. Control samples were included to determine the exact calcium concentration added before the tests.

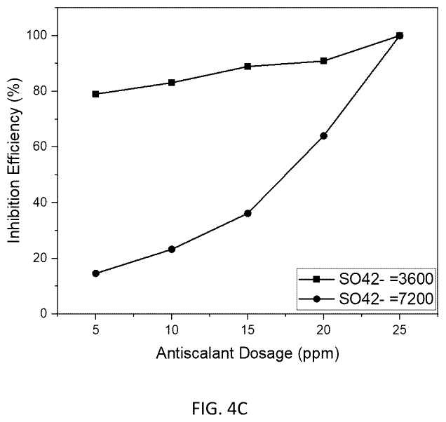

FIGS. 4A-4C are graphs illustrating calcium sulfate scale inhibition efficiencies at 70° C. for different inhibitor dosages. FIG. 4A shows inhibition efficiency for inhibitor dosages 10-50 ppm, Ca²⁺=3000 ppm, SO4²⁻=3600. FIG. 4B shows inhibition efficiency for inhibitor dosages 5-25 ppm at Ca²⁺ of 1500 and 3000 ppm. FIG. 4C shows inhibition efficiency for inhibitor dosages 5-25 ppm at SO4²⁻=3600 and 7200 ppm. The CSiQDs calcium sulfate scaling inhibition performance has been systematically investigated under different conditions. A higher CSiQDs dosage range (10-50 ppm) was first evaluated at the highest scaling brine stress used throughout the current study. This screening test was performed at 70° C. for 10 hours to ensure maximum scale crystal growth. CSiQDs have excellent inhibition performance against gypsum scale, and the results revealed an efficiency higher than 98% with an inhibitor dosage of ≥20 ppm and a maximum efficiency of 100% at a dosage of ≥40 ppm (FIG. 4A). The observed high efficiency at low concentrations makes CSiQDs superior to the other materials reported in the literature since those materials require higher dosages to reach maximum efficiency. For example, the gypsum static bottle inhibition test reveals an efficiency of 100% after only a 200 ppm dosage of carboxyl carbon quantum dots (CCQDs) at 70° C. See, J. Hao et al., “Synthesis and Application of CCQDs as a Novel Type of Environmentally Friendly Scale Inhibitor,” ACS Appl. Mater. Interfaces, vol. 11, no. 9, pp. 9277-9282 Mar. 2019 and M. F. Mady and M. A. Kelland, “Review of Nanotechnology Impacts on Oilfield Scale Management,” ACS Appl. Nano Mater., vol. 3, no. 8, pp. 7343-7364 Aug. 2020. The high inhibition efficiency attained at lower concentrations is attributed to the highly dense carboxyl functionalization facilitated by the abundant amine groups on the synthesized SiQDs.

Hence, the dosages for these testing conditions were in the lower range (5-25 ppm) to be able to differentiate the efficiencies and assess the effect of different factors on scale inhibition performance. Ion concentration, temperature, and pH are among the main factors affecting calcium sulfate precipitation and inhibition; therefore, this study sought to understand the effect of these factors.

FIGS. 4B and 4C reveal the effect of high calcium (Ca²⁺) and sulfate (SO4²⁻) ion concentrations on scale inhibition. Two calcium ion concentrations were tested, Ca²⁺=1500 ppm and Ca²⁺=3000 ppm, while the sulfate ion concentration was fixed at SO4²⁻=3600 ppm. Two sulfate ion concentrations were also tested, SO4²⁻=3600 ppm and SO4²⁻=7200 ppm, while the calcium concentration was fixed at Ca²⁺=1500 ppm. The inhibition efficiency increased with inhibitor dosage at both calcium ion levels (FIG. 4B). CSiQDs tested with a fixed concentration of Ca²⁺=1500 exhibited good inhibition effectiveness (79%) starting at a low dosage of 5 ppm, which increased with dosage and reached 100% at 25 ppm. Doubling the calcium concentration (Ca²⁺=3000) negatively affected inhibition efficiency. Noticeable inhibition efficiency was not recorded at lower inhibitor dosages until an inhibitor dosage of 15 ppm resulted in 70% inhibition efficiency. A maximum inhibition efficiency of 80% was reached at an inhibitor dosage of 25 ppm. Similarly, high sulfate ion concentrations decreased inhibition efficiency, especially at lower dosages, due to the fact that the probability of collision between ions increases at high Ca²⁺ and SO4²⁻ concentrations, which promotes scale formation; however, the inhibition efficiency was still 100% at an inhibitor dosage of 25 ppm and concentration of SO4²⁻=7200 ppm (FIG. 4C). These results indicate the remarkable adaptability and compatibility of CSiQDs in environments involving high concentrations of calcium and sulfate ions.

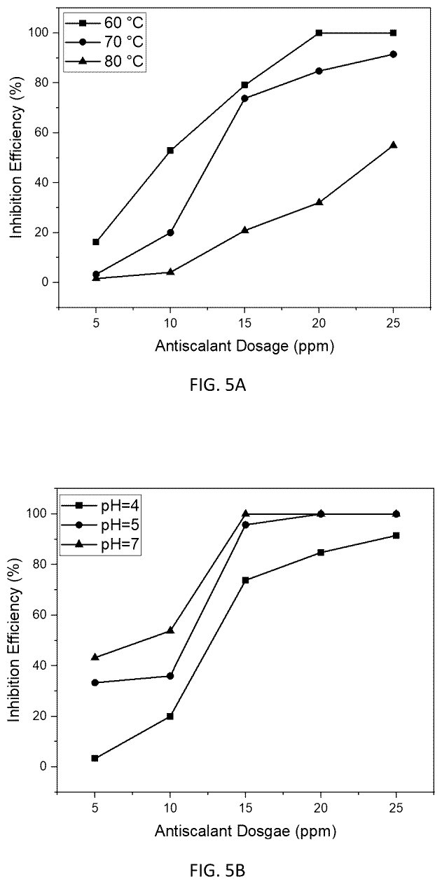

FIGS. 5A and 5B illustrate the effect of temperature and pH on gypsum scale inhibition performance. FIG. 5A shows inhibition efficiencies at 60, 70, and 80° C. and 5-25 ppm inhibitor dosage. FIG. 5B shows inhibition efficiencies at pH of 4, 5, and 7, with temperature kept at 70° C. The CSiQDs scale inhibition rate was very high at lower temperatures, reaching 100% efficiency at a dosage of 20 ppm in the 60° C. solution. The scale inhibition efficiency decreased as temperature increased due to calcium sulfate solubility reduction and the reduction in capacity and rate of CSiQDs on the calcium sulfate scale crystals. CSiQDs exhibit effective inhibition efficiency at high temperatures regardless of the low dosage range used. The inhibitor dosage window was low, the highest dosage used was 25 ppm, indicating that CSiQDs have promising temperature tolerance. The impact of pH on scale inhibition efficiency at three pH levels, 4, 5, and 7, was investigated (FIG. 5B). The inhibition rate increased with an increase in pH, and the efficiency was maintained above 95% at an inhibitor dosage of 15 ppm or higher when the pH increased to 5. The inhibition efficiency increased significantly and was maintained at 100% with an inhibitor dosage of 15 ppm and higher when the pH was increased to 7, which is attributed to the increased solubility of calcium sulfate at higher pH values, promoting scale inhibition. These results indicate that CSiQDs are a good candidate for various water-based industries, where the pH ranges from 5-7. An after-test visualization of the static bottle testing at different dosages was conducted.

### Microbial Contamination Tests

CSiQDs were tested for probable feed water microbial contamination upon injection into a feed water source, given that the product contains organic carbon and no phosphonate-based biocide. This test was performed according to the heterotrophic plate counts (HPCs) of the real field water samples used as the feed in a commercial RO water treatment plant in Grand Forks, North Dakota, USA. Four dosages were tested for HPCs 0.25, 0.5, 0.75, and 1 ppm of CSiQDs and were compared to two commercial antiscalant formulations that contain phosphonate derivatives as a biocide. HPC tests were performed based on SimPlate, an EPA-approved method outlined in Standard Method 9215 Heterotrophic Plate Count. This method detects viable bacteria in water by investigating the existence of key enzymes present in these bacteria/organisms. Multiple enzyme substrates that generate a blue fluorescence when metabolized by waterborne bacteria were used. Antiscalant formulations were injected into 100 ml feed water samples to achieve the desired dosage. 1 ml of each sample was added to the SimPlate plates along with 9 ml of SimPlate media. The SimPlate plates were swirled, and the excess was decanted by tipping the plate to drain the excess into the absorbent pad. The plates were incubated for 8 days, and readings were taken every 24 hours by counting the fluorescent wells under UV light.

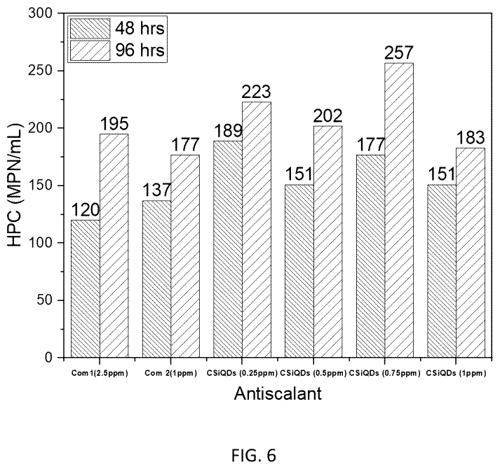

FIG. 6 is a graph showing heterotrophic plate counts (HPC) of feed water samples treated with commercial antiscalants and different concentrations of CSiQDs after 48 and 96-hour incubation periods. The microbial contamination test was performed to ensure that CSiQDs will not compromise the microbiological quality of drinking water and that treated water will be within drinking water standards. Heterotrophic plate Counts (HPC) data are widely utilized to assess drinking water quality and are integrated into drinking water standards, where no more than 500 bacterial colonies per milliliter or MPN/mL is allowed per the EPA guidelines. The testing methodology uses a multiple enzyme method (MET) that targets all most common enzymes of waterborne bacteria. The HPC of the CSiQDs-treated feed water samples was within the standard EPA limit; it was at least 50% lower than the 500 MPN/mL maximum at all concentrations and incubation periods. The HPC counts for the CSiQDs treated samples were comparable to those samples treated with commercial antiscalants, even though the commercial antiscalants contained phosphonate derivatives as biocides (com 1 contained acrylic terpolymer and phosphonic acid derivative and com 2 contained disodium phosphonate, and nitrilotris(methylene) triphosphonic acid).

### Scale Inhibition Mechanism

### Confocal Microscopy Imaging

Confocal images of blank and treated scale samples were acquired to study the effect of CSiQDs on gypsum scale formation. Calcium sulfate nucleation is the first step in bulk heterogeneous crystallization in supersaturated solutions in the presence of impurities/tiny solid particles/Nano-dust. Calcium and sulfate ions will adsorb into the solid impurities and form a gypsum core. In gypsum scale inhibition, carboxylate molecules canbe adsorbed into the gypsum nuclei after gypsum core formation, blocking the active scale growth sites and leading to crystal distortion and growth retardation. This scale inhibition route can be confirmed by observing fluorescent inhibitor molecules on the gypsum crystal surfaces and attached to gypsum crystal edges or core scale.

2D and 3D confocal images of precipitated scale samples in the presence (20 ppm) and absence (blank) of CSiQDs were obtained. Crystals were collected after 10 hours of static bottle test under 70° C. The confocal images of the precipitated scale sample in the blank revealed the formation of conventional needle-like gypsum crystals; however, the formed crystals were no longer needle-shaped in the presence of CSiQDs. A dosage of 20 ppm was chosen to achieve higher fluorescence intensity. The confocal images of the 20 ppm crystal samples revealed an attachment of CSiQDs on the crystal surface and in the core of the gypsum crystal. These findings confirm inhibition via the adsorption of the antiscalant molecules into the active growth sites, hindering the overall scaling rate. To verify this mechanism, live monitoring of gypsum scale formation and growth in the presence of 20 ppm of CSiQDs was also carried out under confocal microscopy for a period of 5 hours.

### X-Ray Diffraction

The gypsum scale crystal structures were analyzed using X-ray diffraction (XRD). XRD patterns of precipitated calcium carbonate scale with and without the presence of CSiQDs, peaks at 20=11.53°, 20.69°, 23.31°, and 29.02° are ascribed to gypsum (CaSO₄·2H₂O). The XRD results for the solution without the scale inhibitor (the blank) revealed major peaks at 2θ=11.53°, 20.69°, 23.31°, and 29.02°, which are ascribed to gypsum (CaSO₄·2H₂O). The resultant gypsum scale did not undergo crystal phase transition after the inhibitor was added. These results suggest that CSiQDs functions to inhibit gypsum scale formation through nucleation and crystal growth distortion, facilitated by the high adsorption capacity resulting from the high dense surface functionalization.

### Scanning Electron Microscopy

The precipitated scale sample morphologies were also studied using SEM. SEM images of the precipitated scale samples after 10 hours of static bottle tests at 70° C. in the presence of CSiQDs (5 ppm) and absence of CSiQDs (blank) were obtained. The scale crystals that precipitated in the blank sample were needle-shaped, similar to the results from the confocal images. The crystals were distorted when CSiQDs was applied, suggesting a crystal growth interference, further confirming the proposed scale inhibition mechanism.

CSiQDs interferes during gypsum nucleation and causes crystal distortion. The component ions adsorb into the solid impurities before nucleation occurs in a supersaturated solution containing Ca²⁺, SO₄²⁻, and tiny solid impurities. Normal nucleation will take place in the absence of CSiQDs, followed by normal crystal growth that produces needle-like gypsum crystals; however, the negatively charged CSiQDs will adsorb into the active sites in the presence of CSiQDs, interfering with nucleation and gypsum crystal growth and inhibiting normal gypsum scale growth, reducing the overall scaling rate. Adsorption onto the gypsum microcrystals will also lead to increased particle repulsion, hindering their coalescence further and preventing scale formation and growth. The faster Brownian motion of tiny CSiQDs facilitated movement, exacerbating gypsum crystal destruction and promoting crystal fragmentation.

The disclosed nanophotonic scale inhibitors provide highly effective scale inhibition at low dosage and offer many advantages, such as green and environmentally friendly technologies, to overcome scaling in different water-based industries. The SiQD core provides fluorescence properties, allowing for monitoring of scale formation. The high surface area of the SiQDs enables highly dense functionalization which renders the formulation highly efficient.

The methods disclosed herein can be used to develop tailor made formulations that target specific water compositions and different scale types, enabled by facile surface functionalization with diverse groups (carboxyl, sulfonate, green phosphonates, etc.). The disclosed nanophonotic scale inhibitors provide high scale inhibition efficiency and antiscalant visualization on scale cores, reverse osmosis (RO) membranes, and engineering equipment, enabled by fluorescence properties. The disclosed nanophotonic scale inhibitors may additionally have antifouling properties that thereby providing dual antiscaling and antifouling functionality.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method for synthesizing a nanophotonic material for scale inhibition and monitoring of water systems, the method comprising:
preparing silicon quantum dots for surface functionalization; and
functionalizing surfaces of the silicon quantum dots with one of a carboxyl group, sulfonate group, and phosphonate group.

2. The method of claim 1, wherein the silicon quantum dots have an amine-enriched surface.

3. The method of claim 1, wherein preparing the silicon quantum dots comprises forming the silicon quantum dots by hydrothermal nucleation.

4. The method of claim 3, wherein the silicon quantum dots are formed from (3-Aminopropyl)triethoxysilane (APTES) in the presence of D-glucose.

5. The method of claim 1, wherein preparing the silicon quantum dots comprises preparing a stable suspension of the silicon quantum dots in a solvent.

6. The method of claim 5, wherein the functionalizing surfaces comprises mixing the stable suspension with a carboxyl source to form a solution.

7. The method of claim 6, wherein the carboxyl source is maleic anhydride or acrylic acid.

8. The method of claim 7 and further comprising adjusting a pH of the solution with the addition of trimethylamine, wherein the adjusted pH is within a range of 8 to 13.

9. A nanophotonic scale inhibitor comprising:
a silicon quantum dot core having a functionalized surface;
wherein the functionalized surface comprises a plurality of carboxyl groups, sulfonate groups, or phosphonate groups.

10. The nanophotonic scale inhibitor of claim 9, wherein the plurality of functional groups are carboxyl groups.

11. The nanophotonic scale inhibitor of claim 10, wherein a particle size of the nanophotonic scale inhibitor ranges from 90-100 nanometers.

12. The nanophotonic scale inhibitor of claim 11, wherein a size of the silicon quantum dot core ranges from 16-23 nanometers.

13. The nanophotonic scale inhibitor of claim 10, wherein the silicon quantum dot core has an amine-enriched surface.

14. A method of inhibiting and monitoring scale formation in water systems, the method comprising:
providing a nanophotonic scale inhibitor to the water in the water system; and
visualizing scale formation by detecting fluorescence of the nanotphotonic scale inhibitor;
wherein the nanophotonic scale inhibitor comprises surface functionalized silicon quantum dots comprising at least one chemical moiety selected from a group consisting of a carboxyl group, sulfonate group, and phosphonate group.

15. The method of claim 14, wherein the nanophotonic scale inhibitor comprises carboxyl silicon quantum dots.

16. The method of claim 15, wherein a concentration of the nanophotonic scale inhibitor provided to the water system is within a range of 15-50 ppm.

17. The method of claim 16, wherein the concentration is within a range of 15-25 ppm.

18. The method of claim 17, wherein a pH of the water system is between 5 and 9.

19. The method of claim 16, wherein a calcium ion concentration of the water system is up to 30,000 ppm.

20. The method of claim 18, wherein a sulfate ion concentration of the water system is up to 7200 ppm.
